(19) United States
(12) Patent Application Publication
(10) Pub. No.: US 2006/0153086 A1
(43) Pub. Date: Jul. 13, 2006

(54) Operation interruption control system for a communication network router

(75) Inventors: Thomas Levy, Paris (FR); Olivier Marce, Massy (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/305,243

(22) Filed: Dec. 19, 2005

(30) Foreign Application Priority Data
Dec. 20, 2004 (FR) 0453063

(51) Int. Cl. H04J 3/14

(52) U.S. Cl. 370/242

(57) ABSTRACT

A system is dedicated to controlling interruption of the operation of a router of an Internet protocol communication network. The system comprises observation means which, in the event of reception of an instruction to observe IP datagrams in transit received by the router, deliver an alert signal in case of absence of detection of IP datagrams during a first selected time period. It further comprises control means which, if it is required to interrupt the operation of the router, instruct processing means to generate outgoing warning messages to other routers reporting the withdrawal of routes for routing of IP datagrams by the router, instruct the observation means to commence an observation, and authorize interruption of the operation of the router in the event of reception of an alert signal from the observation means.

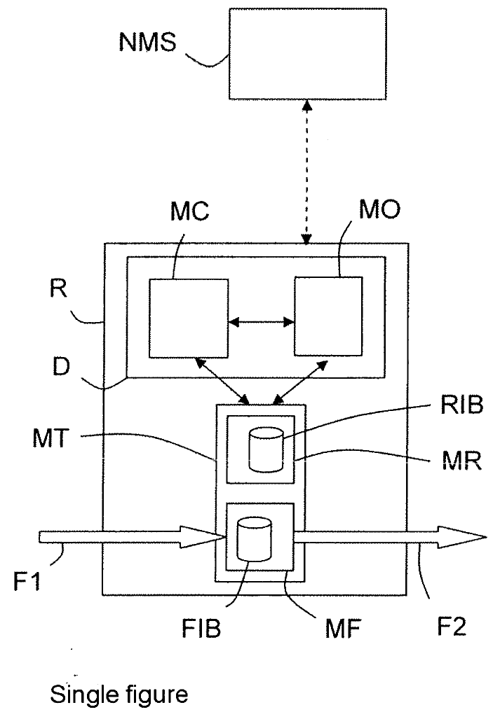

### CROSS-REFERENCE TO RELATED APPLICATIONS

This application is based on French Patent Application No. 0453063 filed Dec. 20, 2004, the disclosure of which is hereby incorporated by reference thereto in its entirety, and the priority of which is hereby claimed under 35 U.S.C. §119.

### BACKGROUND OF THE INVENTION

1. Field of the Invention

The invention relates to intradomain and interdomain routers of Internet Protocol (IP) communication networks and to be more precise to controlling the interruption of operation of such routers.

In the present context, the expression “IP network” refers to a multidomain context consisting of a sum of IP domains (or autonomous systems (AS)) interconnected by access units forming nodes, such as interdomain routers.

Moreover, in the present context the expression “intradomain or interdomain router” refers to a router using a routing protocol, for example the Border Gateway Protocol (BGP) to exchange routing information with other routers belonging either to the same IP domain (or autonomous system (AS)) as itself or to an IP domain other than its own. This routing information is intended to inform each router of the routes enabling each of the routers with which it is “in contact” to route IP data packets (or datagrams) to an adjacent node.

2. Description of the Prior Art

The person skilled in the art knows that to provide some flexibility of use an operator frequently uses a plurality of links (at least two links) between routers of its IP domain and routers of external IP domains. To this end it uses routers redundantly.

This redundancy is particularly beneficial in the event of failure of a router. However, if scheduled maintenance is required on a router involved in a redundancy, for example to replace it with a new router or to modify it, its operation must be interrupted temporarily or permanently. Now, interrupting a router not only removes all its routes for routing IP datagrams, which are used by the network to define the routes of the other routers, but also halts immediately the transmission of IP datagrams in transit coming from those other routers.

After the operation of a router is interrupted, the information on the non-availability of the routes must be propagated in the network in order for the routes of the other routers to be recomputed, which takes a certain time, given the time necessary for BGP type routing to converge. Moreover, once the new routes have been computed, they must be set up by configuring the forwarding engines of the routers in service, which again takes a certain time. Now, during the route computation time and/or the reconfiguration time, IP datagrams transmitted on the old routes passing through the router whose operation has been interrupted may continue to arrive at the interrupted router and therefore be lost.

To solve this problem, there was recently proposed a mechanism for delaying interruption of the operation of a BGP-4 type router. This kind of mechanism is described in the document “Graceful Shutdown of BGP Sessions”, June 2004, available at the Internet address www.ieff.org/internet-drafts/draft-dubois-bgp-planned-maintenance-00.txt on the website of the Internet Engineering Task Force (IETF).

To be more precise, once the decision has been taken to interrupt the operation of a router, the prior art method has the router generate outgoing warning messages to other routers reporting the withdrawal of the routes that enable it to route IP datagrams, after which a predetermined time-delay is triggered, at the end of which the operation of the router is interrupted.

Thanks to this prior art mechanism, the router continues to forward IP datagrams that it receives from other routers of the network throughout the time-delay. Nevertheless, the delay being predetermined, and typically being equal to 300 seconds, it may be either too long or too short, depending on circumstances. Consequently, the router concerned may either continue to operate even if it is already no longer receiving IP datagrams to be forwarded (because the new routes have been recomputed and reconfigured) or cease to operate even if it is still receiving IP datagrams to be forwarded (because the new routes have not yet been recomputed and/or reconfigured).

An aim of the invention is to improve on this situation.

### SUMMARY OF THE INVENTION

To this end the invention proposes a system for controlling interruption of the operation of an (intradomain or interdomain) router of an Internet protocol communication network, which system comprises observation means which, in the event of reception of an instruction to observe IP datagrams (or data packets) in transit received by the router, deliver an alert signal in case of absence of detection of IP datagrams during a first selected time period, and control means which, if it is required to interrupt the operation of the router, instruct processing means to generate outgoing warning messages to other routers reporting the withdrawal of routes for routing of IP datagrams by the router, instruct the observation means to commence an observation, and authorize interruption of the operation of the router in the event of reception of an alert signal from the observation means.

The control system of the invention may have other features and in particular, separately or in combination:
its observation means may observe the received IP datagrams at most for a selected second time period and send an alert signal to the control means if the observation time period becomes equal to the second selected time period;
the second time period is selected in a range from approximately 1 minute to approximately 10 minutes and preferably from approximately 4 minutes to approximately 6 minutes, in particular if the router is of the interdomain type;
the first time period is selected in a range from approximately 0.1 second to approximately 3 seconds and preferably from approximately 0.5 second to approximately 1.5 seconds, in particular if the router is of the interdomain type;
if the router comprises storage means for storing data representing IP datagram routing routes, the control means may instruct the elimination of stored data representing IP datagram routing routes of the router when they have authorized interruption of operation of the router;
it may comprise the processing means;

The invention also proposes an (intradomain or interdomain) router for an IP communication network, comprising a control device as described above.

This kind of router may comprise storage means in the form of a routing information base (RIB) and/or a forwarding information base (FIB) dedicated to IP datagram routing routes.

If the control system does not include the processing means, the latter means are installed in the router and used for generating outgoing messages to other routers either comprising information data representing routes for routing IP datagrams or reporting the withdrawal of the IP datagram routing routes of the router.

The invention is particularly well adapted, although not exclusively so, to interdomain routers of the BGP type.

### BRIEF DESCRIPTION OF THE DRAWING

Other features and advantages of the invention will become apparent on reading the following detailed description and examining the appended drawing, the single figure in which is a highly diagrammatic representation of an interdomain router equipped with one embodiment of a control system of the invention. The appended drawing constitutes part of the description of the invention as well as contributing to the definition of the invention, if necessary.

### DETAILED DESCRIPTION OF THE PREFERRED EMBODIMENT

An object of the invention is to control interruption of the operation of an intradomain or interdomain router of an Internet Protocol (IP) communication network in order to limit the consequences thereof, in particular in terms of loss of IP datagrams (or data packets).

In the following description by way of illustrative example the router is of the interdomain type. The invention is not limited to that type of router, however. It relates equally to intradomain routers.

It is further considered hereinafter that the interdomain router is of the Border Gateway Protocol (BGP) type. As indicated in the introduction, in the present context the expression “BGP router” refers to a router using a BGP type routing protocol to exchange routing information with another BGP router belonging either to the same IP domain (or autonomous system (AS)) as itself or to an IP domain other than its own.

As shown functionally and diagrammatically in the single figure, a (BGP) router R comprises, firstly, a processing module MT including a routing module MR and at least one transmission (or forwarding) module MF connected to its interfaces (not shown).

The routing module MR comprises storage means generally known as a routing information base (RIB) for storing routing data (or information) used to route IP datagrams (or data packets) to a subsequent router. It is responsible for collecting routing information contained in incoming BGP messages (indicated by the arrow F1) received via the input interfaces of the router R from BGP routers to which its router R is connected and including information data representing routes or routing IP datagrams, in order to supply that information to the routing information base RIB.

The routing information base RIB generally includes a very large number of entries each of which is used to store an item of routing information relating to a known router IP address (or prefix). Of this information, some relates in particular to the (re)transmission of IP datagrams (in transit).

The routing module MR also generates, as a function of routing data stored in the routing information base RIB, outgoing BGP messages (indicated by the arrow F2) also comprising information data representing routes for routing IP datagrams and intended to be forwarded by the forwarding module MF and via the output interfaces to the BGP routers connected to its router R.

The forwarding module MF is coupled to the interfaces of the router R in order, firstly, to receive streams from the other routers and in particular incoming BGP messages (arrow F1) for the routing module MR, and, secondly, to (re)transmit streams and in particular outgoing BGP messages for the other routers supplied by the routing module MR (arrow F2).

The forwarding module MF comprises storage means generally known as the forwarding information base (FIB) for storing routing data (or information) for routing IP datagrams (or data packets) to a subsequent router.

The forwarding information base FIB essentially contains (re)transmission information extracted from the routing information base RIB. The forwarding information base FIB contains entries each storing one item of forwarding information relating to a known router address (or prefix).

The routing data (or information) stored in the storage means RIB and FIB constitutes what is usually called a routing table.

The forwarding module MF also comprises a switching matrix (not shown) that may be configured as a function of instructions supplied by the network (generally by its network management system (NMS)), address information contained in the IP datagrams to be (re)transmitted, and routing information contained in the forwarding information base FIB. The switching matrix is generally connected to memories for locally adding and/or locally dropping IP datagrams and temporarily storing IP datagrams received over one of the interfaces.

Thanks to the incoming and outgoing BGP messages, the information data that defines the routes of the network may be propagated from one BGP router to another BGP router to supply their routing tables with updated routing data and configure their switching matrix.

According to the invention, at least certain of the routers R are equipped with a control system D for controlling interruption of their operation when the operator of the network requests this, for example via his NMS.

As shown diagrammatically and functionally in the single figure, the control system D comprises at least one observation module MO and one control module MC.

It is important to note that the control system D could equally comprise the processing module MT described above.

Each time that it receives the corresponding instruction from the control module MC, the observation module MO observes IP datagrams in transit received over the interfaces of the router R. If it does not observe any IP datagram during a first selected time period, it delivers an alert signal to the control module MC.

To this end, as soon as the observation module MO first detects that the router is not receiving IP datagrams, it triggers a time-delay whose maximum duration is equal to the first time period. If the router R does not receive any IP datagram during that time-delay, the observation module MO delivers its alert signal. Otherwise, the observation module MO interrupts the time-delay and waits until the router R is no longer receiving IP datagrams to trigger the time-delay again.

The first time period is from approximately 0.1 second to approximately 3 seconds, for example, and preferably from approximately 0.5 second to approximately 1.5 seconds. It may be equal to 1 second, for example. This first time period can preferably be configured by the operator. The above values are more particularly adapted to interdomain type routers. Other values must be chosen in the case of intradomain type routers.

To avoid the observation phase lasting too long, the observation module MO may be configured so that it is able to observe the received IP datagrams only during a second selected time period.

To this end, as soon as the observation module MO receives an observation instruction, it triggers another time-delay whose maximum duration is equal to the second time period. If the router R receives IP datagrams throughout this other time-delay, the observation module MO delivers its alert signal. If not, it is the time-delay equal to the first time period that prevails (remember that if the router R does not receive any IP datagrams during the first time-delay the observation module MO delivers an alert signal).

The second time period is from approximately 1 minute to approximately 10 minutes, for example, and preferably from approximately 4 minutes to approximately 6 minutes. It may be equal to 5 minutes, for example. This second time period can preferably be configured by the operator. The above values are more particularly adapted to interdomain type routers. Other values must be chosen in the case of intradomain type routers.

Each time it receives from the operator of the network, for example via the NMS, a request to interrupt the operation of the router R, the control module MC firstly instructs the processing module MT to generate outgoing BGP warning messages to other routers reporting the removal of all the routes that the router R uses to route IP datagrams and secondly instructs the observation module MO to commence observation in accordance with the procedure described above.

The BGP warning messages are entirely conventional. They are what the person skilled in the art knows as update messages, the withdrawn route field whereof is not empty. In fact, this field contains the designations of the routes to be withdrawn.

When the BGP routers of the network that are participating in a BGP session with the router R for which interruption of operation has been requested receive a BGP warning message, they update their respective routing tables (stored in their storage means RIB and FIB). The network can then compute new routes that do not pass through the router R for which interruption of operation has been requested and then proceed to reconfigure the routers of those new routes.

It is important to note that the control module MC does not authorize the elimination of information data representing routes for routing IP datagrams of its router R which are stored in the storage means RIB and FIB even though it has instructed the transmission of warning messages reporting the withdrawal of said routes. As will emerge later, this elimination of information data may optionally be authorized once the operation of the router R has been interrupted.

Once the control module MC has sent its instructions to the processing module MT and the observation module MO, it waits for the observation module MO to send it an alert signal.

Once the control module MC has received the alert signal from the observation module MO, it is able to authorize interruption of the operation of the router R.

The time at which the alert signal is received varies as a function of the time period during which the router continues to receive IP datagrams from other routers with which it has set up one or more IP sessions. In fact, the observation module MO waits for the alert signal for at least the first time period and at most the second time period. The waiting time therefore depends on the current topology of the network and the current traffic, and not on an arbitrary choice. Consequently, the operation of the router R is interrupted as soon as it no longer receives any IP datagrams during a first time period or, in the worse case scenario, once the second time period has elapsed.

Once the control module MC has authorized interruption of the operation of the router R, it preferably sends the storage means RIB and FIB an instruction to eliminate the information data that represents the routes for routing IP datagrams of the router R. The routing table of the router R is therefore reset and can therefore be reconstituted thanks to new BGP sessions once the router R is ready to operate again.

The control system D of the invention, and in particular its control module MC and its observation module MO, as well as its processing module MT, if any, may take the form of electronic circuits, software (or electronic data processing) modules, or a combination of circuits and software.

The invention is not limited to the control system and router embodiments described hereinabove by way of example only, but encompasses all variants that the person skilled in the art might envisage that fall within the scope of the following claims.

1. A system for controlling interruption of the operation of a router of an Internet protocol communication network, which system comprises observation means which, in the event of reception of an instruction to observe IP datagrams in transit received by said router, deliver an alert signal in case of absence of detection of IP datagrams during a first selected time period, and control means which, if it is required to interrupt the operation of said router, instruct processing means to generate outgoing warning messages to other routers reporting the withdrawal of routes for routing of IP datagrams by said router, instruct said observation means to commence an observation, and authorize interruption of the operation of said router in the event of reception of an alert signal from said observation means.

2. The system according to claim 1, wherein said observation means observe said received IP datagrams at most for a selected second time period and send an alert signal to said control means if said observation time period becomes equal to said second selected time period.

3. The system according to claim 2, wherein said second time period is selected in a range from approximately 1 minute to approximately 10 minutes.

4. The system according to claim 1, wherein said first time period is selected in a range from approximately 0.1 second to approximately 3 seconds.

5. The system according to claim 2, wherein said first time period is selected in a range from approximately 0.1 second to approximately 3 seconds.

6. The system according to claim 3, wherein said first time period is selected in a range from approximately 0.1 second to approximately 3 seconds.

7. The system according to claim 1, wherein in the presence of storage means for storing data representing IP datagram routing routes, said control means instruct the elimination of stored data representing IP datagram routing routes of said router when they have authorized interruption of operation of said router.

8. The system according to claim 2, wherein in the presence of storage means for storing data representing IP datagram routing routes, said control means instruct the elimination of stored data representing IP datagram routing routes of said router when they have authorized interruption of operation of said router.

9. The system according to claim 3, wherein in the presence of storage means for storing data representing IP datagram routing routes, said control means instruct the elimination of stored data representing IP datagram routing routes of said router when they have authorized interruption of operation of said router.

10. The system according to claim 1, comprising said processing means.

11. The system according to claim 2, comprising said processing means.

12. The system according to claim 3, comprising said processing means.

13. An interdomain router for an Internet protocol communication network, said router comprising a control system as claimed in claim 1.

14. The router according to claim 13, comprising storage means in the form of a routing information base and/or a forwarding information base dedicated to IP datagram routing routes.

15. The router according to claim 13, comprising processing means for generating outgoing messages to other routers comprising information data representing routes for routing IP datagrams and outgoing warning messages to said other routers reporting the withdrawal of the IP datagram routing routes of said router.

16. The router according to claim 14, comprising processing means for generating outgoing messages to other routers comprising information data representing routes for routing IP datagrams and outgoing warning messages to said other routers reporting the withdrawal of the IP datagram routing routes of said router.

17. The router according to claim 13, of the BGP type.

18. The router according to claim 14, of the BGP type.

19. The router according to claim 15, of the BGP type.
